(19) United States
(12) Patent Application Publication
(10) Pub. No.: US 2014/0216886 A1
(43) Pub. Date: Aug. 7, 2014

(54) Under Counter Utensil Chute With Hanger Bracket

(71) Applicant: Frank W. Jones, Pompano Beach, FL (US)

(72) Inventor: Frank W. Jones, Pompano Beach, FL (US)

(21) Appl. No.: 14/171,968

(22) Filed: Feb. 4, 2014

Related U.S. Application Data
(60) Provisional application No. 61/760,316, filed on Feb. 4, 2013.

(51) Int. Cl. B65G 11/02

(52) U.S. Cl. CPC B65G 11/026
USPC 193/2 R

(57) ABSTRACT

A chute for mounting on an elevated surface having a passageway extending from a first end to a second end, the first end having a flange for supporting the chute on an elevated surface, and engaging an edge of the elevated surface, to support the chute. The passageway has a slope such that soiled eating utensils placed within the chute will pass through the passageway and out the second end of the chute into a waiting receptacle such as a tub or bin to receive soiled utensils to be washed.

### INDEX TO RELATED APPLICATIONS

This application claims the benefit of U.S. Provisional Patent Application 61/760,316 filed on Feb. 4, 2013, the disclosure of which is incorporated herein by reference in its entirety.

### BACKGROUND OF THE INVENTION

The present invention is primarily used in a kitchen environment of a restaurant in the area where soiled dishes and silverware are returned to the kitchen for cleaning or dishwashing. In this dishwasher area, typically a busboy or other personal would deposit soiled dishes and soiled silverware for the dishwasher to clean. The soiled dishes are stacked on a soiled dish table. The flatware is often deposited in a soaking bin. This soaking bin is often portable and located on wheels under the soiled dish table. However, since the busboy is often in a hurry, placing the soiled dishes on the soiled dish table is relatively easy since the table is in full view. The flatware soaking bin is located below the soiled dish table and therefore inadvertently when the soiled flatware is being deposited in the soaking bin, oftentimes the flatware misses the soaking bin and ends up on the floor. This caused the soiled flatware to get dirtier and causes a mess on the floor taking more time for the personal to clean and pick up. What is needed is a better and quicker way to deposit the soiled flatware in the soaking bin and to make sure all the flatware goes into the soaking bin.

### BRIEF SUMMARY OF THE INVENTION

The present invention is an under counter chute for directing soiled silverware or flatware to a flatware soaking bin located under a soiled dish table. The chute is removably clasped to a soiled dish table. The chute as a first open end and a second open end and is aligned such that when soiled flatware is deposited in the first end, the soiled flatware is directed through the chute out the second end to fall in a utensil soaking bin located under the soiled dish table and just below the second end of the chute.

### BRIEF DESCRIPTION OF THE DRAWINGS

FIG. 1 is a perspective view of the utensil chute of the present invention.

FIG. 2 is sectional view of the utensil chute from FIG. 1 along line A-A.

FIG. 3 is a cross sectional view of the utensil chute mounted on a soiled dish table with a utensil soaking bin under the soiled dish table.

FIG. 4 is an end view of the chute mounted on one end of a soiled dish table which is shown in a perspective view with the utensil soaking bin under the table and the end of the chute to receive the utensils.

FIG. 5 is an alternate embodiment shown as a sectional view similar to FIG. 3, where the hook is designed to engage a different type of soiled dish table having a bull nose edge.

FIG. 6 is an alternate embodiment shown as a sectional view similar to FIG. 2, where the hook is shown as a separate part so that the chute can be modified to hook on to a soiled dish table with either type of bull nose edging.

FIG. 7 is a modified version of the alternate embodiment as shown in FIG. 5, where the hook engages the entire bull nose edge of the table and includes an extension that extends laterally along a portion of the top of the table.

### DETAILED DESCRIPTION OF THE PREFERRED EMBODIMENT

A description of the preferred embodiment is set forth herein and in the accompanying drawings.

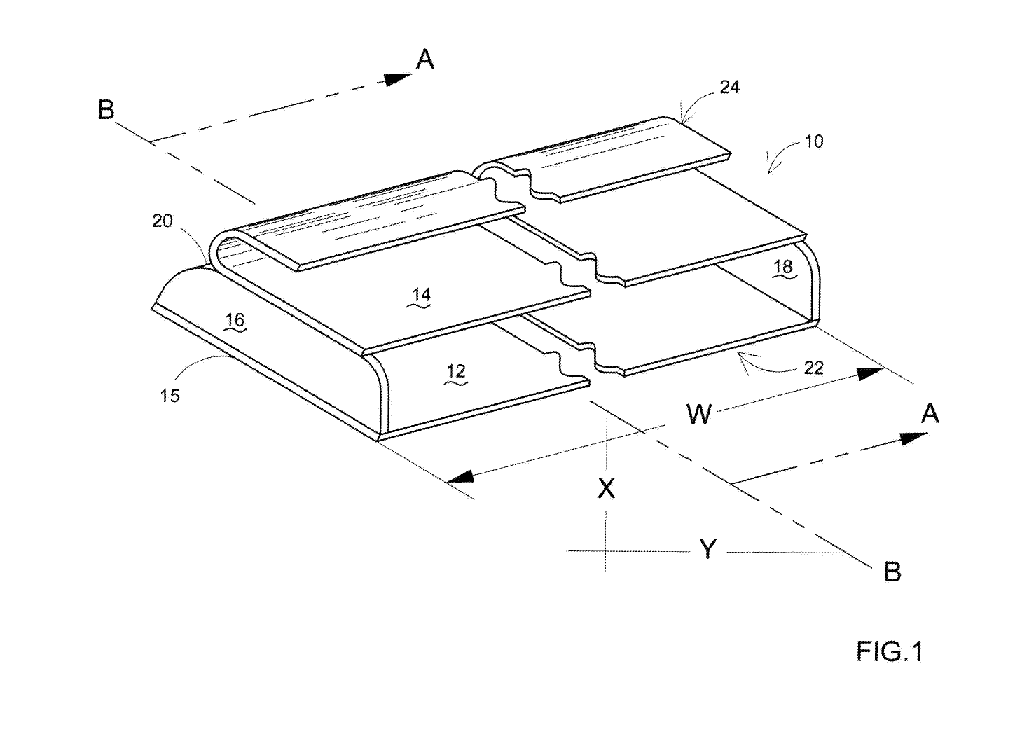

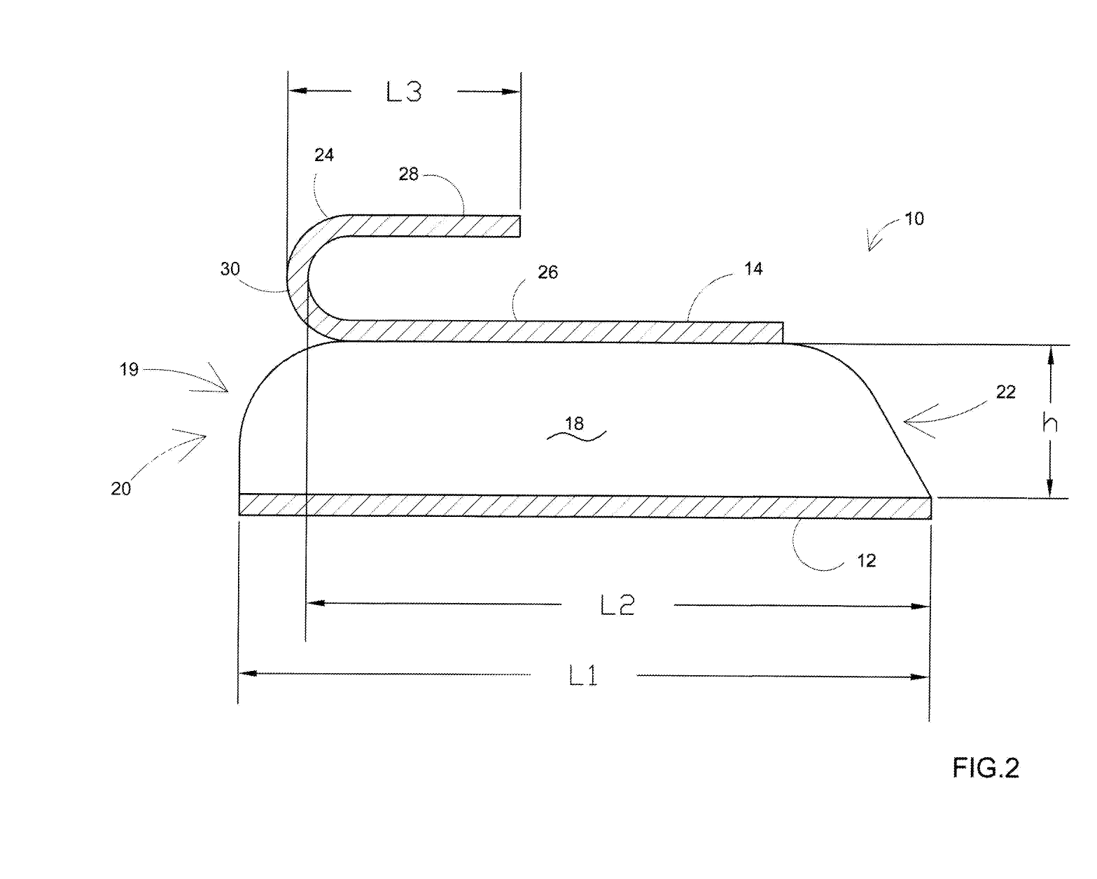

Referring to FIGS. 1 and 2, chute 10 has four walls connected on the longitudinal edges, a bottom wall 12, an opposed top wall 14, and opposed side walls 16 and 18. Walls 12, 14, 16 and 18 form an elongated chute, a channel or passageway 19 down which falling material is guided. Said chute 10 has a first end 20 and a second end 22 at opposite ends of the chute 10. Top wall 14, close to or part of the first end 20 has as a part thereof or attached thereto a mounting hook or flange 24. Flange 24 is generally “U” shaped and is attached or extends from top wall 14 to form a bracket to removably secure chute 10 to a surface. Chute 10 thus has a body portion 15 and a flange 24. A first chute side 26 of flange 24 is formed with and a part of or attached to wall 14. A second table side 28 of flange 24 is spaced apart from chute side 26 and wall 14. The top portion 30 of flange 24 is generally “U” shaped or other shape to conform to a surface to which it attaches.

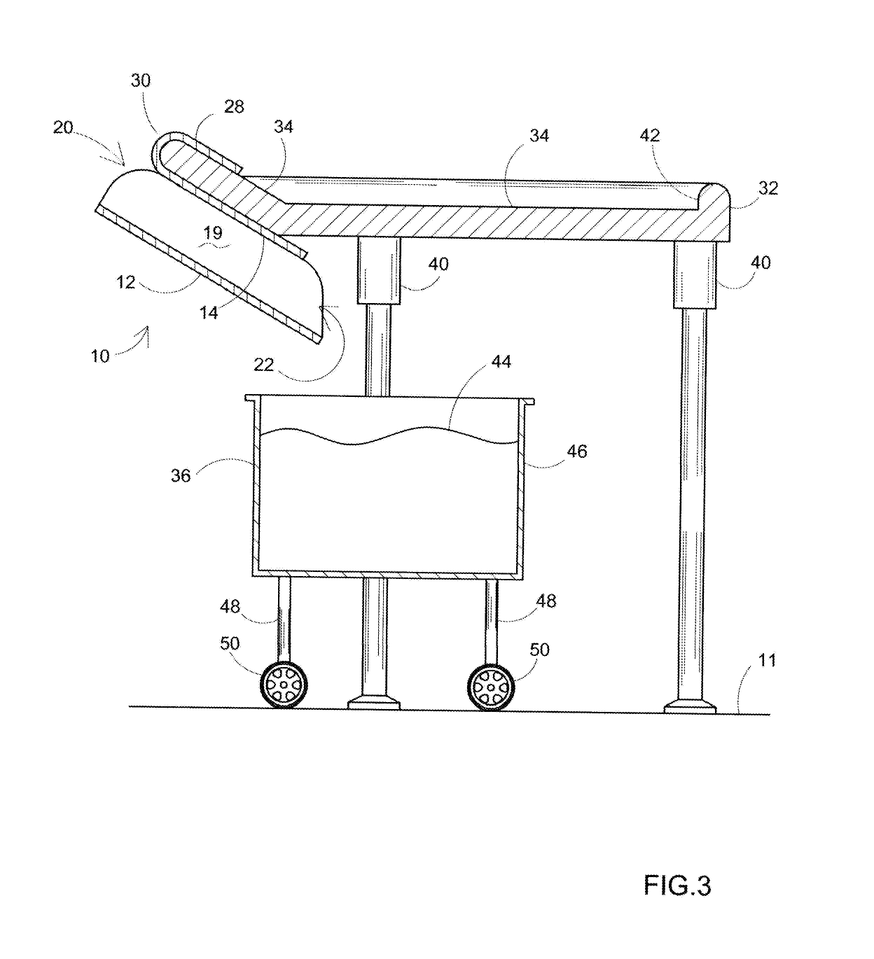

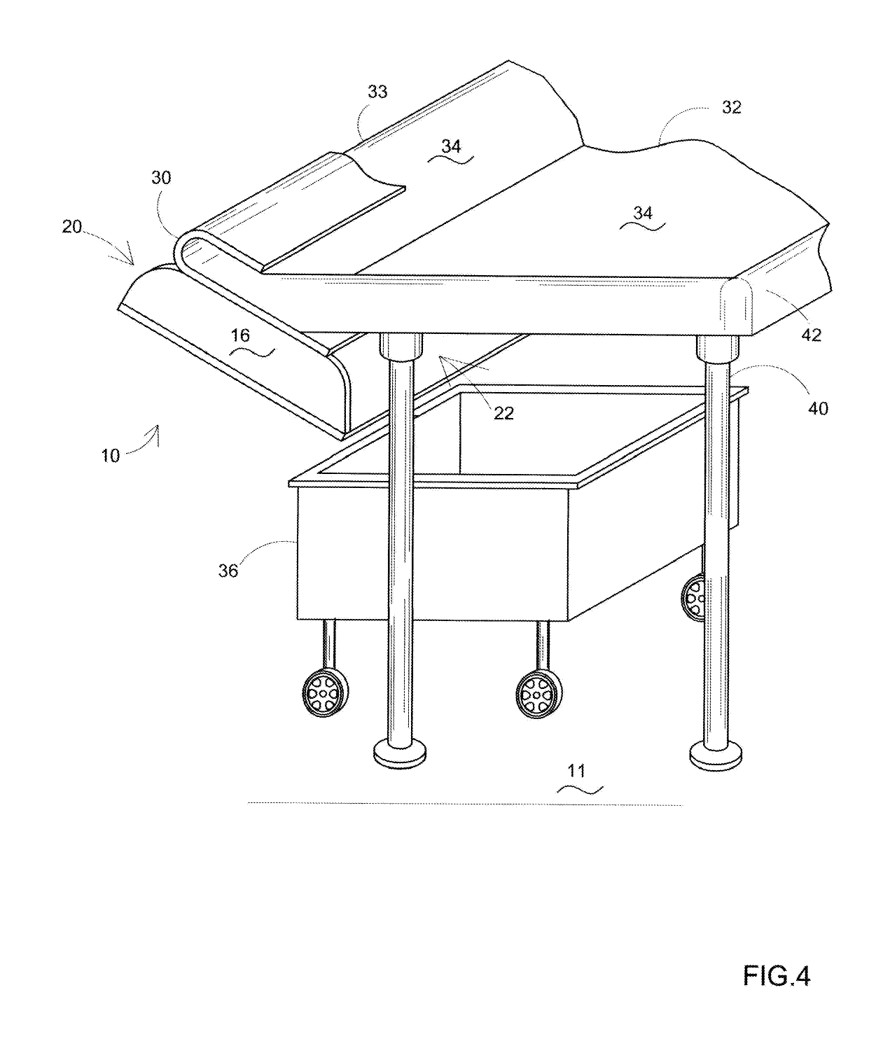

As seen in FIGS. 3 and 4, chute 10 attaches to a soiled dish table 32. Table 32, when used, has placed thereon to its surfaces 34 soiled dishes (not shown). Said dishes are typically returned, by a busboy, to the soiled dish table 32 after dishes used in a restaurant (for example) have been soiled and need to be cleaned. The busboy typically collects or gathers dishes and eating utensils and glasses or cups, after use, from the dining tables where people are eating. The busboy then deposits the soiled dishes on the soiled dish table 32 and utensils, such as silverware or flatware are deposited into a utensil soaking bin 36. Alternatively in a self-serve cafeteria or dining room, patrons may return eating trays with soiled dishes and eating utensils. Similarly the utensils would be deposited into a soaking bin 36 by inserting the utensils to slide down chute 10.

Chute 10 is attached to an edge of a surface such as table 32 which has an edge 33 such that flange 24 securely supports chute 10 on table 32 at edge 33. The top 30 of flange 24 conforms to edge 33, the inside portion of side 28 is against the top of surface 34 and the chute side 26 of flange 24 is against the bottom of surface 34 at and near edge 33. Chute 10 is thus held against edge 33 and the underside surface of surface 34 such that chute 10 is orientated at an angle to the ground whereby chute 10 has a downward slope from first end 20 to second end 22. First end 10 being higher from the ground than second end 20. As seen in FIGS. 3, 4 and 5, chute 10 has a downward slope such that items placed into first end 20 will pass down through passageway 19 of chute 20 and out second end 22.

As seen in FIG. 3, table 32 has legs 40 extending from the bottom of table 32 to the ground 11, to support table 32. Table 32 typically includes a retaining wall 42 so water and other materials are contained within table 32 and do not fall to the ground 11. Below table 32, soaking bin 36 typically contains a liquid soaking solution 44 held within the walls 46 of bin 36. Bin 36 is supported by legs 48 typically on wheels 50, since bin 36 is often moved within the kitchen area of a restaurant from the collection point below table 32 to the dishwasher in order to empty the utensils there from.

In use, bin 36 is located below table 32 and chute 10 is attached to the edge 33 of table 32. Chute 10 is aligned along edge 33 so that second end 22 of chute 10 is above bin 36. Flange 24 of chute 10 is placed on edge 33 and can be slideably moved along said edge to align the end 22 with bin 36. When the busboy or other personal return soiled dishes and utensils, the utensils are placed into chute 10 at first end 20 where the utensils will pass through passageway 19 through chute 10 and out second end 22 and the utensils will drop into bin 36 and into a cleaning or disinfecting solution 44.

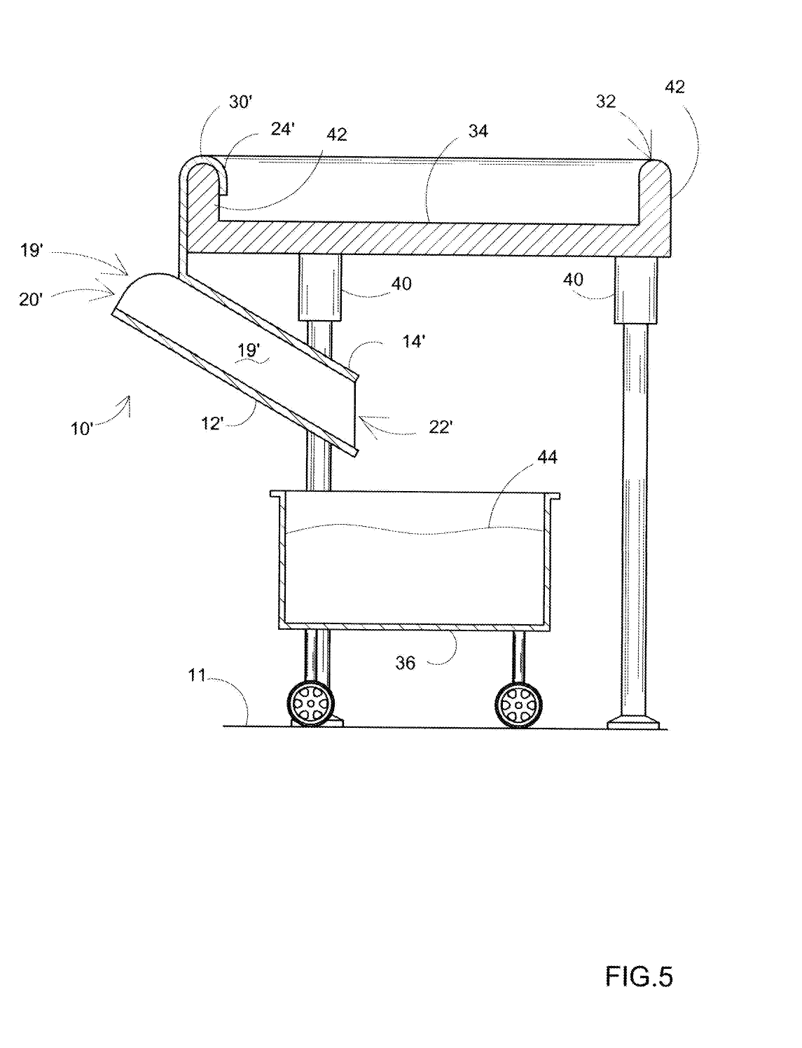

As seen in FIG. 5, an alternate embodiment of flange 24′ can be seen where flange 24′ conforms to a portion of retaining wall 42, yet chute 10′ is still maintained in a sloped position where first end 20′ is above second end 22′ and the slope of passageway 19′ is downward and utensils placed in passageway 19′ will exit out end 22′ and slide into bin 36. Top wall 14′ and bottom wall 12′ are generally parallel to each other.

Passageway 19 has a slope as shown in FIG. 1 of x over y, said slope is less than the value of 1.0. Longitudinal line B-B is orientated along the length of chute 10 and passageway 19 within chute 10. Along line B-B, x is the vertical distance relative to the difference in height from the ground of first end 20 to second end 22 and y is the horizontal distance between first end 20 and second end 22. These relationships may be similar in all of the embodiments of the invention.

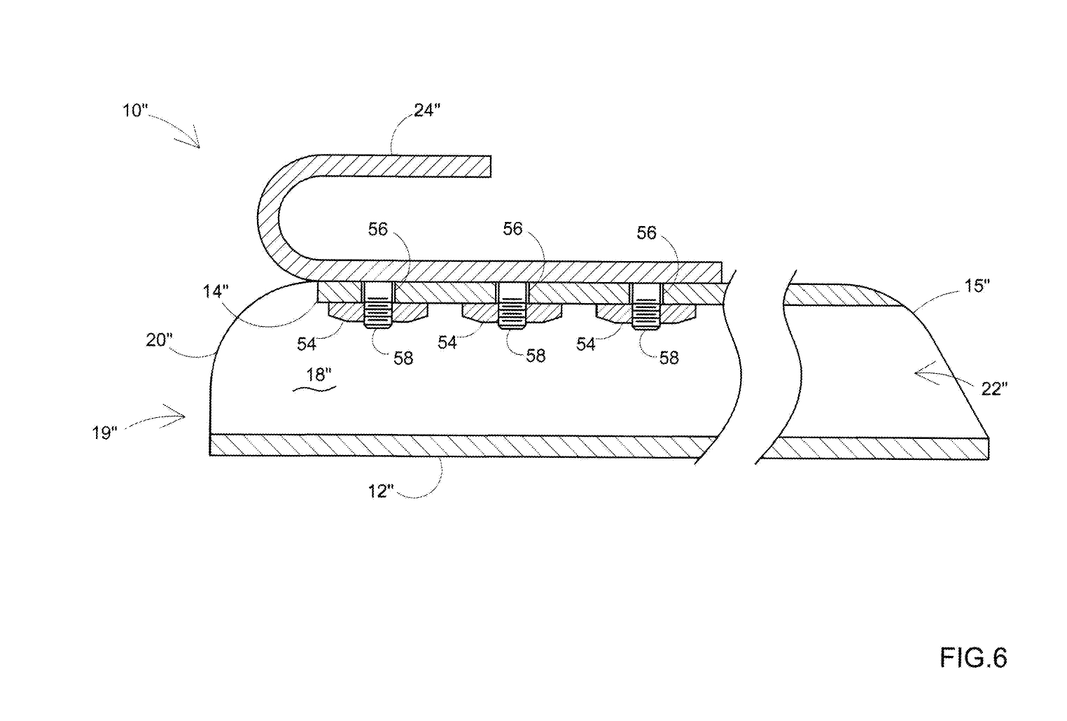

In FIG. 6, an alternate embodiment of chute 10″ is shown having a body portion 15″ and an attachable flange portion 24″. In this alternate embodiment, a flange 24″ can be attached that is designed to conform to the edge 33 of table 32. Preferably a chute 10″ may be sold or packaged with one or more flanges 24″ to allow chute 10″ to be attachable to one of several designs of table 32. Flange 24″ is securely attached to wall 14″ near first end 20″ by three threaded studs 58 welded to flange 24″ on the inside edge 26 of the chute 10″. The welded threaded studs 58 are secured by a cap nut 54 or the like and hold body portion 12 to flange 24″. One or more openings 56 in the wall 14″ of flange 24″ would be aligned with corresponding threaded studs 58. Nut 54 would be a cap nut, nut, locking nut or other fastener as known in the art. The threaded studs 58 would preferably be even with or protrude as little as possible from the table side 26 of flange 24″ and likewise, fastener 54 would protrude into passageway 19 as little as possible. The fastener 54 would preferably be rounded as to allow minimal interference with anything coming down the chute 10″. The first end 20″ and the second end 22″ would still be at an angle to permit flatware and the like to slide down the passageway 19″ of the chute 10″. Alternatively, the flange 24″ can be welded directly to the chute 10″ as shown in FIG. 6, without use of the studs and nuts.

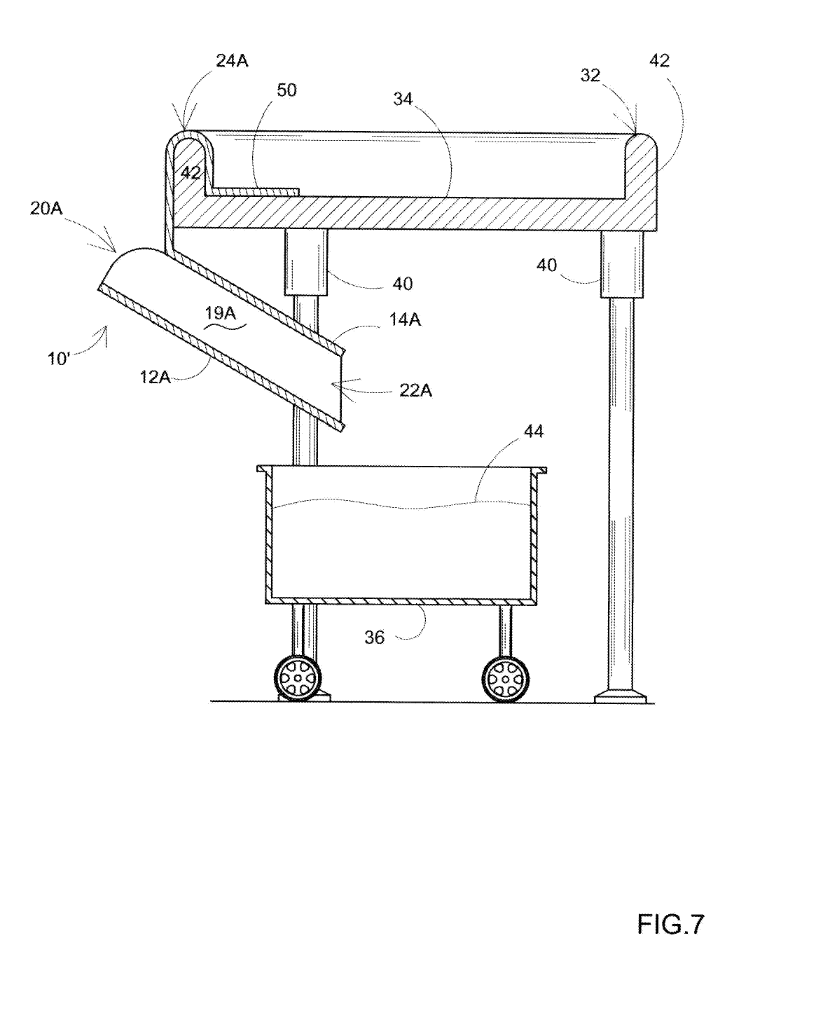

As seen in FIG. 7, an alternate embodiment of flange 24A can be seen where flange 24A conforms to the entirety of retaining wall 42 and includes a contiguous lateral extension 50 which extends over a portion of the table top 34. This would give the chute 10A greater stability as well as the ability to handle a greater weight of silverware, flatware and the like as they pass through the passageway 19A. Chute 10A is still maintained in a sloped position where first end 20A is above second end 22A and the slope of passageway 19A is downward. Thus utensils placed in the first opening 20A will slide down passageway 19A and exit out second end 22A and egress into bin 36. Top wall 14A and bottom wall 12A are generally parallel to each other.

Chute 10 is preferably constructed of stainless steel though other materials can be used. In a preferred embodiment, passageway 19 of chute 10 has an internal width ‘w’ of about 9-11 inches, wall 12 has a length ‘L1’ of about 19-21 inches, wall 14 has a length ‘L2’ of about 17-19 inches, side 28 of flange 24 has a length ‘L3’ of about 10-12 inches and passageway 19 has an internal height ‘h’ of about 3-7 inches. The distance between ‘L2’ and ‘L3’ is about 1-2 inches. The above dimensions may be changed to allow the chute to be employed with different table structures or other horizontal surfaces.

While the invention has been described in its preferred form or embodiment with some degree of particularity, it is understood that this description has been given only by way of example and that numerous changes in the details of construction, sizes, fabrication, and use, including the combination and arrangement of parts, may be made without departing from the spirit and scope of the invention.

I claim:

1. A chute for mounting on an elevated surface comprising:
said chute forming a passageway having a first end and a second end, said passageway extending from said first end to said second end,
said first end having a flange for supporting said chute on an elevated surface, said flange engaging an edge of said elevated surface, whereby said chute is constructed and arranged on said elevated surface such that said passageway has a slope and said first end has a greater vertical height above ground than said second end, and said second end is below said elevated surface, and items placed within said first end of said chute will pass through said passageway and out said second end of said chute.

2. A chute for mounting on an elevated surface as claimed in claim 1 wherein said flange includes an upper side and a lower side, said lower side including a plurality of welded threaded studs which pass through a plurality of apertures located on a top wall of said passageway, said plurality of welded threaded studs have a plurality of mating threaded fasteners attached thereto securing said flange to said passageway.

3. A chute for mounting on an elevated surface as claimed in claim 1 wherein said flange is attached to said chute by welding said flange to said chute.

4. A chute for mounting on an elevated surface as claimed in claim 1 wherein said elevated surface is horizontal and includes a top, said flange upper side is connected to flange lower side by a curved flange section, said flange upper side including a lateral extension which extends horizontally across a portion of said top elevated surface.

5. A chute for mounting on an elevated surface as claimed in claim 1 wherein said passageway includes a top wall, a bottom wall, and a pair of sidewalls.

6. A chute for mounting on an elevated surface as claimed in claim 5 wherein said bottom wall is longer than said top wall.

7. A chute for mounting on an elevated surface as claimed in claim 6 wherein said pair of sidewalls are generally parallel.

8. A chute for mounting on an elevated surface as claimed in claim 7 wherein said flange and passageway are comprised of stainless steel.

9. A chute for mounting on a table having a retaining wall about the table perimeter, the table proximal to a washing area for dishes, utensils and other accoutrements of eating comprising:
a chute having an upper wall, a lower wall, and a pair of sidewalls forming a passageway,
said passageway having a first opening and a second opening, said first opening above said second opening, providing said chute with a downward slope, said pair of sidewalls spaced apart by a first distance,
a u-shaped flange resting atop the retaining wall about the table perimeter, a first side of said u-shaped flange integral with said upper wall proximal said first opening, a second side of said u-shaped flange covering the majority of the retaining wall along said first distance whereby,
said second opening is positioned above the bin of cleaning solution, and the utensils and other accoutrements of eating are placed in said first opening of said chute where they slide through said passageway and exit from said second opening into the bin of cleaning solution.

10. A chute for mounting on a table as claimed in claim 9 wherein said u-shaped flange extends completely about retaining wall along said first distance and includes a contiguous lateral portion which rests on the top of the table.

11. A chute for mounting on a table as claimed in claim 10 wherein said pair of sidewalls are generally parallel.

12. A chute for mounting on a table as claimed in claim 11 wherein said lower wall is longer than said upper wall.

13. A chute for mounting on a table as claimed in claim 12 wherein said chute is made from stainless steel.

14. A chute for mounting on a table to permit dirty utensils and other dining accoutrements to be placed into a bin of cleaning solution underneath the table, said chute comprising:
a table mounting flange mounted atop a chute, said table mounting flange slidingly engaged with the edge of the table, said chute having a top wall, a bottom wall, and a pair of sidewalls, said top wall, bottom wall and pair of sidewalls forming a passageway, said passageway having a first opening and a second opening, said top wall including a downward bend whereby the dirty utensils and other accoutrements are placed in said first opening where they slide down said passageway and egress out said second opening falling into the bin of cleaning solution.

15. A chute for mounting on a table as claimed in claim 14 wherein said bottom wall is longer than said top wall.

16. A chute for mounting on a table as claimed in claim 15 wherein said pair of sidewalls are generally parallel.

17. A chute for mounting on an elevated surface as claimed in claim 16 wherein said flange and passageway are comprised of stainless steel.
